(19) United States
(12) Patent Application Publication
(10) Pub. No.: US 2025/0151935 A1
(43) Pub. Date: May 15, 2025

(54) COLLAPSIBLE PILLOW WITH CUSHIONING GRID

(71) Applicant: Purple Innovation, LLC, Lehi, UT (US)

(72) Inventor: Jennifer Ellen Williams, Mapleton, UT (US)

(73) Assignee: Purple Innovation, LLC, Lehi, UT (US)

(21) Appl. No.: 18/943,394

(22) Filed: Nov. 11, 2024

Related U.S. Application Data
(60) Provisional application No. 63/548,213, filed on Nov. 12, 2023.

(51) Int. Cl. A47G 9/10

(52) U.S. Cl. CPC A47G 9/10; A47G 2009/1018

(57) ABSTRACT

A pillow includes a core cushion and at least one cushioning grid superimposed with the outer surface of the core cushion. The core cushion includes an outer surface and opposite side edges. The at least one cushioning includes opposite side edges positioned adjacent to the opposite side edges of the core cushion, the opposite side edges of the at least one cushioning grid defining a width; a central axis extending along the width; and a plurality of interconnected walls defining a plurality of voids and oriented over the outer surface, the plurality of interconnected walls configured to collapse within the plurality of voids when the opposite side edges of the at least one cushioning grid are forced toward each other in a direction that is substantially parallel to the central axis to collapse the pillow.

### CROSS-REFERENCE TO RELATED PATENT APPLICATION

This application claims the benefit of and priority to U.S. Provisional Application No. 63/548,213, filed Nov. 12, 2024, which is incorporated by reference herein in its entirety and for all purposes.

### BACKGROUND

This disclosure relates generally to pillows. More specifically, this disclosure relates to collapsible pillows. Even more specifically, this disclosure relates to collapsible pillows with cushioning grids. This disclosure also relates to methods for designing, manufacturing, and using collapsible pillows.

Pillows that includes cushioning grids have become increasingly popular in recent years. These include the Purple Pillow, available from Purple Innovation LLC (purple.com/pillows/purple-pillow/2) and described by U.S. Pat. Nos. 10,772,445, 10,863,837, and 11,812,880, the Purple Harmony Pillow, available from Purple Innovation, LLC (purple.com/pillows/harmony/2) and described in U.S. Patent Application Publication US 2020/0390247 A1, and the cylindrical cushion disclosed by U.S. Design patent application Ser. No. 29/779,639, the entire disclosures of which are hereby incorporated herein.

While the cushioning grids of these pillows provide unique cushioning effects and may also provide cooling effects, they prevent the pillows from optimally collapsing through their widths. In particular, the cushioning grids include interconnected walls that define hexagonal and/or triangular grids, with many of the walls being aligned along, or parallel to, central axes extending across the widths of such pillows. These walls cause the cushioning grids to buckle (e.g., the outer surfaces thereof to include hills and valleys, etc.) when these pillows are collapsed along their longest dimensions—their widths. Such buckling effectively increases the thicknesses of the cushioning grids, which introduces the amount of force required to collapse the pillows and may damage the cushioning grids.

### SUMMARY

One embodiment relates to a pillow, including: a core cushion including an outer surface and opposite side edges; and at least one cushioning grid superimposed with the outer surface of the core cushion and including: opposite side edges positioned adjacent to the opposite side edges of the core cushion, the opposite side edges of the at least one cushioning grid defining a width; a central axis extending along the width; and a plurality of interconnected walls defining a plurality of voids and oriented over the outer surface, the plurality of interconnected walls configured to collapse within the plurality of voids when the opposite side edges of the at least one cushioning grid are forced toward each other in a direction that is substantially parallel to the central axis to collapse the pillow.

Another embodiment relates to a method for manufacturing a collapsible pillow, the method including: providing a core cushion collapsible upon application of opposed converging forces along a central axis across a width of the core cushion; and positioning a cushioning grid including interconnected walls over an outer surface of the core cushion, without substantially any wall of the interconnected walls being oriented parallel to the central axis of the core cushion.

Another embodiment relates to a pillow, including: a cushioning grid including opposite side edges and a plurality of interconnected walls, wherein the plurality of interconnected walls are oriented such that the plurality of interconnected walls collapse without substantially increasing in thickness when at least one of the opposite side edges of the cushioning grid is forced toward another of the opposite side edges to collapse the pillow.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a top perspective view of an embodiment of a pillow cushion of a pillow of the present disclosure;

FIG. 2 is a top perspective view of the pillow cushion of FIG. 1 in a cover;

FIG. 3 is a bottom perspective view of the pillow cushion of FIG. 1 in a cover;

FIG. 4 is a top plan view of the pillow cushion of FIG. 1;

FIG. 5 is side view of the pillow cushion of FIG. 1;

FIG. 6 is a side view of an embodiment of the pillow cushion of FIG. 1;

FIG. 7 is a top plan view of an embodiment of the pillow cushion of FIG. 1;

FIG. 8 is a top plan view of an embodiment of the pillow cushion of FIG. 1;

FIG. 9 is a top plan view of an embodiment of the pillow cushion of FIG. 1; and

FIG. 10 is a top plan view of an embodiment of the pillow cushion of FIG. 1.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, various aspects of collapsible pillows and their design, manufacture, and use are disclosed. While the ensuing disclosure refers primarily to pillows and, more specifically, to pillows with cushioning grids, it may also be applicable to other types of cushions with configurations that enable them collapse.

A collapsible pillow or cushion (e.g., a travel pillow, a readily storable pillow, etc.), which may also be more simply referred to herein as a “pillow,” may have a configuration that enables it to collapse from its normal, or relaxed, dimensions, to significantly smaller dimensions (e.g., half or less of its relaxed volume, one third or less of its relaxed volume, one fourth or less of its relaxed volume, one fifth or less of its relaxed volume, etc.). The reduced dimensions of the collapsible pillow in the compressed configuration reduces the packaging volume required for shipping or transporting the pillow, which can, beneficially, both reduce costs for a manufacturer due to the reduced volume required during shipping, and increase convenience for a user transporting the pillow.

A pillow according to this disclosure may include cushioning grid. The cushioning grid may be oriented in a manner that enables the cushioning grid and, thus, the pillow of which the cushioning grid is a part to collapse as its side edges, or ends, are forced together (e.g., pushed together, etc.).

In some embodiments, the cushioning grid may comprise a primary cushioning element of the pillow. The primary cushioning element may include the cushioning grid. Alternatively, the primary cushioning element of the pillow may consist essentially of the cushioning grid; for example, the primary cushioning element may include non-essential elements, such as a cover, one or more boosters, or the like. As another alternative, the primary cushioning element of the pillow may consist of the cushioning grid.

Optionally, such a pillow may include a cover.

The cushioning grid of such a pillow may be somewhat flat. It may include opposite side edges, or ends, with a width of the cushioning grid and, thus, of the pillow extending between the opposite side edges. The width of the cushioning grid may be its longest dimension and, thus, a dimension that is likely to be shortened as the cushioning grid and the pillow of which it is a part are collapsed. A central axis of the cushioning grid and, thus, the pillow may extend through a center of the cushioning grid, from one side edge to the opposite side edge. The cushioning grid may collapse as one of the side edges is forced toward the opposite side edge in a direction that is parallel to or substantially parallel to (e.g., oriented at an angle of about 15° or less to, about 10° or less to, about 5° of less to, etc.) the central axis.

The cushioning grid includes interconnected walls that define an array of geometric prisms, or columns. The interconnected walls may define an array of regular hexagons (i.e., a hexagonal array), an array of rhombi or rhomboid prisms (e.g., squares, diamonds, etc.) (i.e., a rhomboidal array), an array of triangles (i.e., a triangular array), or the like. The array may be oriented in such a way that, when one of its side edges is forced toward the other or its opposite side edges are forced together, it may collapse without substantially buckling relative to a plane over which it is collapsed, or without substantially effectively increasing its thickness. For example, the cushioning grid may be oriented so that none of the walls or substantially none of the walls (e.g., no more than 10% of the walls, no more than 5% of the walls, no more than 2% of the walls, no more than 1% of the walls, etc.) of the cushioning grid is oriented substantially parallel to the central axis of the cushioning grid, or substantially parallel to the direction(s) in which the pillow is likely or intended to be collapsed.

The walls of the cushioning grid may be formed from any suitable cushioning material. In some embodiments, the walls of the cushioning grid may be formed from an elastomeric polymer or gel. Examples of such a gel include plasticizer-extended block copolymers (e.g., a triblock copolymer, an A-B-A triblock copolymer, etc.), such as those disclosed by U.S. Pat. Nos. 6,413,458, 6,797,765, and 7,964,664, the entire disclosures of which are hereby incorporated herein. As used herein, the term “elastomeric polymer” means and includes a polymer capable of recovering its original size and shape after deformation. In other words, an elastomeric polymer is a polymer having elastic or viscoelastic properties. Elastomeric polymers may also be referred to as “elastomers” in the art. Elastomeric polymers include, without limitation, homopolymers (polymers having a single chemical unit repeated) and copolymers (polymers having two or more chemical units).

In other embodiments, the pillow may include a core cushion and at least one cushioning grid assembled with the core cushion. Optionally, such a pillow may include a cover.

The core cushion may include an outer surface. In embodiments where the core cushion has the shape of a bed pillow, the outer surface may include oppositely facing major surfaces. In other embodiments, the core cushion may be substantially cylindrical in shape, with its outer surface corresponding to the circumferential surface of the cylinder. Other shapes of core cushions and their outer surfaces are also within the scope of this disclosure.

The core cushion includes opposite side edges. The opposite side edges of the core cushion are located at opposite ends of a width of the core cushion. The width of the core cushion may be its longest dimension and, thus, a dimension that is likely to be shortened as the core cushion and the pillow of which it is a part are collapsed. A central axis of the core cushion (or of the pillow), along which the core cushion (and the pillow) may be collapsed, extends from one end of the core cushion to the other end of the core cushion, or across or through its width.

The core cushion may have any suitable configuration. As some examples, it may comprise a single piece of cushioning material or it may include a collection of cushioning elements (e.g., pieces, particles, etc.) held together in a pliable container, or the like.

The core cushion may be formed from any suitable material or combination of materials. Without limitation, a single-piece core cushion may be formed from a foam, such as a latex foam (e.g., Talalay latex, Dunlop latex, etc.), a polyurethane foam, or the like. The core cushion may also be formed of a fabric envelope filled with a soft cushioning material such as with synthetic or natural fiber-fill, down feathers, an elastomeric polymer or gel, or other fillers for a pillow.

The at least one cushioning grid may be somewhat flat. It may include opposite side edges, or ends. The opposite side edges may be located at opposite ends of a width of the cushioning grid, which may correspond to a width of the core cushion with which the cushioning grid is to be used. Each side edge may be positioned near or adjacent to a corresponding side edge of the core cushion.

The number of cushioning grids such a pillow includes may correspond to a shape of the core cushion. For example, a pillow that includes a core cushion with oppositely facing major surfaces (e.g., a core cushion having the shape of a bed pillow, etc.) may include a cushioning grid superimposed with one of the major surfaces (e.g., a single cushioning grid) or a cushioning grid superimposed with each major surface (e.g., two cushioning grids). As another example, a pillow with a core cushion that has a substantially cylindrical shape may include one cushioning grid, which may substantially surround the outer surface of the core cushion.

Each cushioning grid includes interconnected walls that define an array of geometric prisms, or columns. The interconnected walls may define an array of regular hexagons (i.e., a hexagonal array), an array of rhombi (e.g., squares, diamonds, etc.) (i.e., a rhomboidal array), an array of triangles (i.e., a triangular array), or the like. The array may be oriented in such a way that, when at least one of its opposite side edges is forced toward the other opposite side edge (e.g., if a core cushion is included, when the opposite side edges of the core cushion are pushed together, etc.), it may collapse without buckling, or without substantially effectively increasing its thickness. For example, the cushioning grid may be oriented over the outer surface of the core cushion so that substantially none of the walls or none of the walls of the cushioning grid are oriented substantially parallel to the central axis of the core cushion (and a central axis of the pillow), or substantially parallel to the direction(s) in which the pillow is to be collapsed. The compressed position allows for benefits in packaging the pillow for transport by reducing a total volume of the pillow.

A cushioning grid may have a substantially uniform thickness. Alternatively, a thickness of a cushioning grid may taper from a central portion of the cushioning grid toward at least one edge (e.g., toward the opposite side edges, toward each edge, etc.) of the cushioning grid.

The walls of the cushioning grid may be formed from any suitable cushioning material. In some embodiments, the walls of the cushioning grid may be formed from an elastomeric gel. Examples of such a gel include plasticizer-extended block copolymers (e.g., a triblock copolymer, an A-B-A triblock copolymer, etc.), such as those disclosed by U.S. Pat. Nos. 6,413,458; 6,797,765; and 7,964,664.

In some embodiments, including embodiments where the cushioning grid comprises or is the primary cushion of the pillow and embodiments in which a cushioning grid is superimposed over an outer surface of a core cushion, the pillow may include an optional cover.

In embodiments where the pillow includes a core cushion and at least one cushioning grid, the cover may be positioned over the core cushion. The cover may carry the at least one cushioning grid. Examples of the manner in which a cover may carry a cushioning grid are disclosed by U.S. Patent Application Publication US 2020/0390247 A1.As an example, the cushioning grid may be located within a pocket of the cover. As another example, the cushioning grid may be secured to (e.g., formed on and partially impregnate, be adhered to, etc.) a panel of the cover.

A method for designing a pillow (e.g., a collapsible pillow, such as a travel pillow, a readily storable pillow, etc.) includes determining a direction in which the pillow is likely to be collapsed or is intended to be collapsed (e.g., across its width, etc.). In addition, the features of at least one cushioning grid (e.g., shape of prisms in the grid, etc.) may be determined. An orientation of each cushioning grid that will enable it to optimally collapse (e.g., without buckling or effectively increasing in thickness, etc.) when the pillow is collapsed in the predetermined direction is also determined.

A method for manufacturing a pillow (e.g., a collapsible pillow, such as a travel pillow, a readily storable pillow, etc.) includes defining a cushioning grid from a suitable cushioning material. The cushioning grid is defined by defining interconnected walls that are oriented to enable the cushioning grid to collapse along its width without buckling, or without effectively increasing its thickness. More specifically, the cushioning grid may be defined in such a way that none of the walls or substantially none of the walls is oriented parallel to or substantially parallel to a central axis of the pillow, or a direction in which the pillow is likely or intended to be collapsed. The interconnected walls of the cushioning grid may define an array of polygonal prisms (e.g., hexagonal prisms, rhomboidal prisms, triangular prisms, etc.).

Another method for manufacturing a pillow (e.g., a collapsible pillow, such as a travel pillow, a readily storable pillow, etc.) includes providing a core cushion and positioning at least one cushioning grid over an outer surface of the core cushion. The core cushion may be collapsible upon application of a force along or in a direction substantially parallel to a central axis across a width of the core cushion. Each cushioning grid includes interconnected walls that are oriented so that no wall or substantially no wall of the interconnected walls is oriented parallel to the central axis of the core cushion, or substantially parallel to the direction(s) in which the core cushion is likely or intended to be collapsed. The interconnected walls of the cushioning grid may define an array of polygonal prisms (e.g., hexagonal prisms, rhomboidal prisms, triangular prisms, etc.) over the outer surface of the core cushion. The cushioning grid may be positioned over the core cushion by placing a cover that carries the cushioning grid over the core cushion.

A method for storing and/or transporting a pillow includes collapsing the pillow. The pillow may be collapsed by forcing (e.g., pushing, etc.) ends of the pillow together along a central axis through a width of the pillow. As the ends of the pillow (e.g., a cushioning grid of the pillow, a core cushion of the pillow, etc.) are forced together, each cushioning grid of the pillow may collapse. If the cushioning grid is properly oriented (e.g., without substantially any walls of the cushioning grid substantially being parallel or substantially parallel to the central axis of the pillow, to the direction in which the pillow is likely or intended to be collapsed, etc.) the cushioning grid may collapse without buckling or, thus, effectively increasing its thickness. As the at least one cushioning grid collapses, the walls of the at least one cushioning grid may move into spaces, or cells, defined between the walls, decreasing the volumes of the spaces, or cells. Such collapsing may continue until the walls of the at least one cushioning grid contact each other.

Once a collapsing force is removed, the pillow (e.g., the core cushion, each cushioning grid, etc.) may expand substantially to its relaxed width, or substantially to its original dimensions and volume. Such expansion may occur due to the resiliency of one or more parts of the pillow (e.g., its core cushion, its cushioning grid(s), etc.).

Other aspects of the disclosed subject matter, as well as features and advantages of various aspects of the disclosure, should be apparent to those of ordinary skill in the art through consideration of the preceding disclosure, the accompanying drawings, and the appended claims.

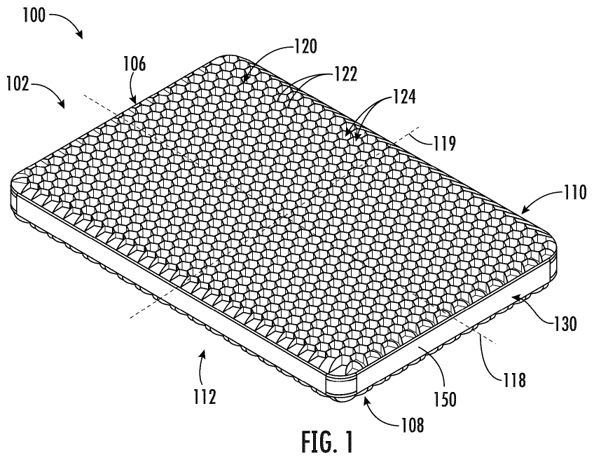

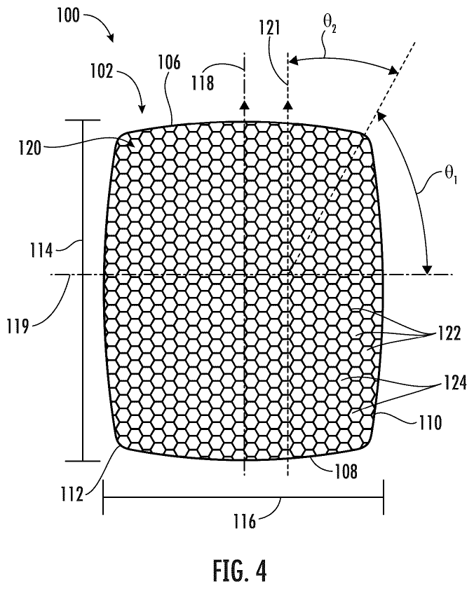

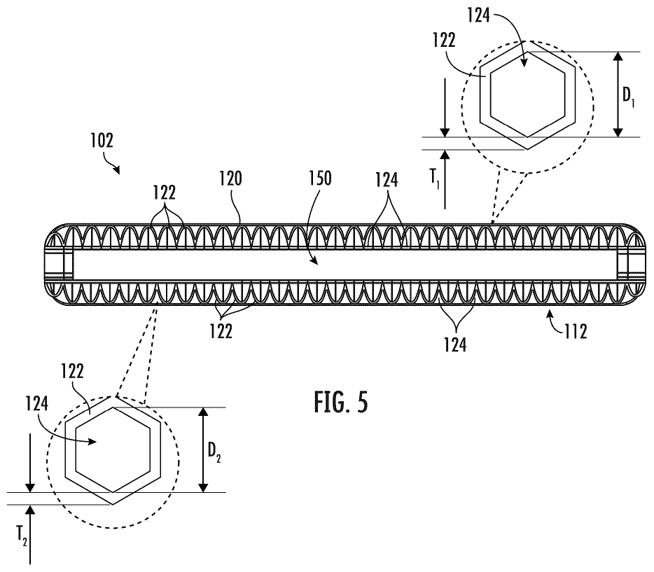

FIG. 1 illustrates an embodiment of a pillow cushion 102 of a pillow 100 of the present disclosure. FIG. 4 illustrates a top plan view of the pillow cushion 102. The pillow cushion 102 includes a cushioning grid 120 with a plurality of interconnected walls 122. The pillow cushion 102 includes opposite side edges including a first side edge 106 opposite a second side edge 108, and a front edge 110 opposite a back edge 112. The first side edge 106 and the second side edge 108 are at opposite ends of width 114 of the pillow cushion 102 which extends between the first side edge 106 and the second side edge 108. A first central axis 118 of the pillow cushion 102 extends through a center of the cushioning grid 120 from the first side edge 106 to the second side edge 108. A second central axis 119 extends through a center of the cushioning grid 120 from the front edge 110 to the back edge 112 defining a depth 116 of the pillow cushion 102.

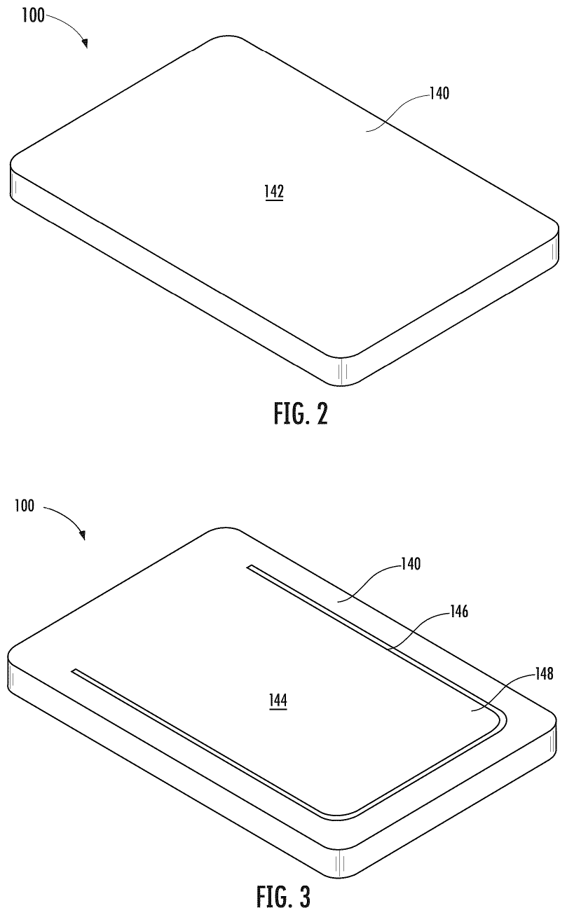

FIGS. 2 and 3 illustrate a perspective view of the pillow cushion 102 in a pillow cover 140. The pillow cover 140 includes an upper side 152 and an opposing lower side 154. In some embodiments, the cushioning grid 120 is carried in a pocket of the pillow cover 140, such that providing the pillow cover 140 around the core cushion 150 also provides the cushioning grid 120 around the core cushion 150. The pocket may be defined as the void between two layers of a fabric element. In some embodiments, the core cushion 150 is excluded. In such embodiments, the main structure of the pillow cushion 102 may be the cushioning grid 120.

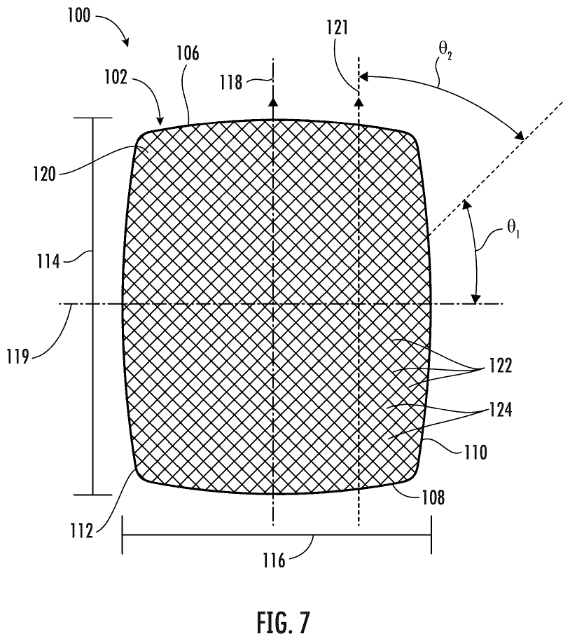

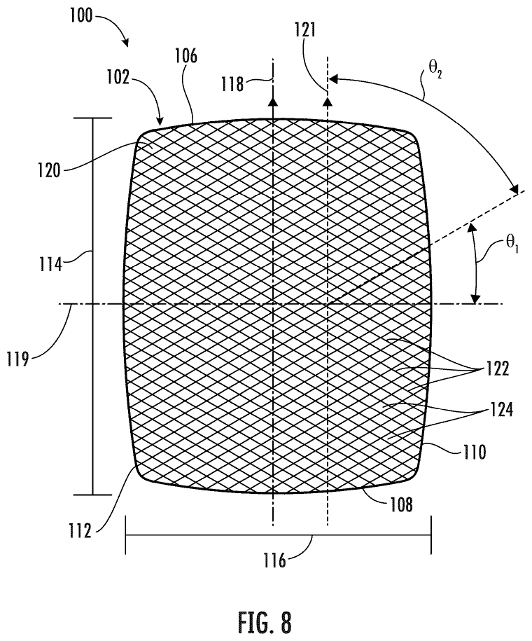

The plurality of interconnected walls 122 define a plurality of voids 124 such as an array of geometric prisms or columns. As shown in FIGS. 1 and 4-6, the interconnected walls 122 define a plurality of voids 124 defining an array of regular hexagons (i.e., a hexagonal array). As shown in FIG. 7, the interconnected walls 122 define a plurality of voids 124 defining an array of rhombi (e.g., squares, diamonds, etc.) (i.e., a rhomboidal array). However, in other embodiments, a different shape and/or size may be defined. As shown in FIG. 8, the interconnected walls 122 define a plurality of voids 124 defining an array of triangles (i.e., a triangular array). In some embodiments, the interconnected walls 122 may define a plurality of voids 124 defining an array of other geometric shapes.

Referring back to FIG. 1, the plurality of voids 124 in the array of interconnected walls 122 may be oriented in such a way that, when one of the first side edge 106 or the second side edge 108 is forced toward the other of the first side edge 106 or the second side edge 108, the first side edge 106 and the second side edge 108 are forced together, it may collapse without substantially buckling relative to a plane over which it is collapsed, or without substantially effectively increasing its thickness. All of the walls 122 of the cushioning grid 120 may be oriented at an angle θ₁ of approximately 0° to 60 ° relative to the second central axis 119 of the pillow cushion 102 (i.e., relative to the depth 116 between front edge 110 and back edge 112 of the pillow cushion 102). Thus, all of the walls 122 of the plurality of interconnected walls may be oriented at an angle θ₂ of 30 ° to 90° (or approximately at these angles) relative to an axis 121 parallel to a first central axis 118 across or through the width of the pillow cushion 102 (i.e., between the first and second side edges 106, 108, or ends, of the pillow cushion 102), or to the direction(s) in which the pillow or cushion are to be compressed or collapsed. θ₂ may be the smaller angle of the pair of adjacent supplementary angles with a common side parallel with the wall 122, with the other angle being θ₁+90°, that together from a line parallel with the first central axis 118. θ₁ and θ₂ may therefore be complementary angles. Thus, each wall 122 of the plurality of interconnected walls 122 may be oriented along an axis that intersects the first central axis 118 at some point (i.e., is non-parallel to the central axis 118). The plurality of interconnected walls 122 of the cushioning grid 120 thus may lack walls that are parallel to the first central axis 118 and the axis 121 across the width 114 of the pillow cushion 102. For example, the cushioning grid 120 may be oriented over the outer surface of the core cushion 150 so that substantially none (e.g., no more than 10% of the walls, no more than 5% of the walls, no more than 2% of the walls, no more than 1% of the walls, etc.) of the walls or none of the walls 122 of the cushioning grid 120 are oriented substantially parallel to the first central axis 118 of the core cushion 150 (and a central axis of the pillow cushion 102 or the cushioning grid 120), or substantially parallel to the direction(s) in which the pillow cushion 102 is to be collapsed. The orientation of the walls at angle θ₂ of 30° to 90° to the axis 121, and therefore to the first central axis 118, the orientation of the interconnected walls along an axis that intersects the axis 121 and/or the first central axis 118, and/or the lack of walls that are parallel to the first central axis 118 allow for the pillow cushion 102 to collapse without substantially buckling relative to a plane over which it is collapsed (i.e., the plane defined by the width 114 and the depth 116), or without substantially effectively increasing its thickness (i.e., increase in size in a direction perpendicular to the plane defined by the width 114 and the depth 116). When collapsing, the interconnected walls 122 extend into the plurality of voids 124, allowing the pillow cushion 102 to collapse along the first central axis 118 without a substantial increase in thickness. In some embodiments, the cushioning grid 120 has a substantially uniform thickness. In some embodiments, a thickness of the cushioning grid 120 tapers from a central portion of the cushioning grid 120 toward at least one edge (e.g., the first side edge 106, the second side edge 108) of the cushioning grid 120.

The cushioning grid 120 is positioned over an outer surface of a core cushion 150 of the pillow cushion 102. The core cushion 150 may be shaped like a pillow. In some embodiments the core cushion 150 has a cylindrical or substantially cylindrical shape. The core cushion 150 may be formed from any suitable material or combination of materials. Without limitation, a single-piece core cushion 150 may be formed from a foam, such as a latex foam (e.g., Talalay latex, Dunlop latex, etc.), a polyurethane foam, or the like. The core cushion 150 may also be formed of a fabric envelope filled with a soft cushioning material such as with synthetic or natural fiber-fill, down feathers, an elastomeric polymer or gel, or other fillers for a pillow. Alternatively, the cushioning grid may comprise the primary cushion of the pillow or cushion. In some embodiments, the pillow cushion 102 does not include the core cushion 150.

FIGS. 4 and 7-8 depict cushioning grids 120 with acceptable patterns of plurality of interconnected walls 122 and plurality of voids 124 that satisfy θ₁ and θ₂ as discussed above. In each of FIGS. 4 and 7-8 none of the walls 122 of the cushioning grid 120 extend parallel or substantially parallel to the second central axis 119 through or across the width 114 of the pillow cushion 102, the cushioning grid 120, or the core cushion 150, if any, or to direction(s) in which the pillow cushion 102 is expected to be compressed (i.e., from the first side edge 106 and the second side edge 108 of each figure). The angle represented in each of FIGS. 4 an 7-8 by θ₁ refers to the largest angle of any wall 122 of the cushioning grid relative to the second central axis 119 and/or the depth 116 of the pillow cushion 102. The angles represented by θ₂ may be the smaller angle of the pair of adjacent supplementary angles with a common side parallel with the wall 122 that together form a line on axis 121 parallel with the second central axis 119. θ₁ and θ₂ may be complimentary angles such that the maximum angles θ₂ of 60°, 45°, and 30° of the FIGS. 4 and 7-8 correspond respectively to minimum angles θ₁ of 30° 45° and 60° of the walls 122 of the illustrated cushioning grids 120 to the respective central axes 118 and 119 of the pillow cushion 102, or the direction(s) along which the pillow cushion 102 are likely to be compressed or intended (i.e., designed) to be compressed or collapsed.

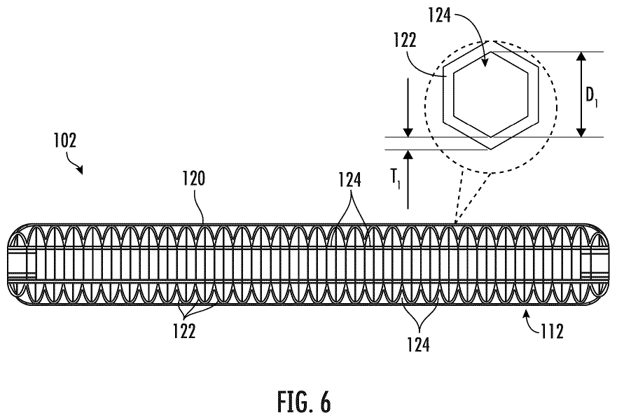

Referring specifically to FIGS. 4-6, the interconnected walls 122 define a plurality of voids 124 which define an array of regular hexagons (i.e., a hexagonal array). The largest angle of any wall 122 of the cushioning grid 120 relative to the axis 121 parallel to the first central axis 118 and/or the width 114 of the pillow cushion 102 represented by θ₁ is 60° relative to the second central axis 119, and the complementary angle θ₂ is 30° relative to the 118. As shown in FIG. 5, core cushion 150 may have a cushion grid 120 on a top side and a bottom side of the core cushion 150. The top cushioning grid 120 includes a plurality of walls 122 with a thickness T1 which define a plurality of voids 124 with a diameter D1. The bottom cushioning grid 120 includes a plurality of walls 122 with thickness T2 which define a plurality of voids with a diameter D2. In some embodiments, T1 is equal to T2, whereas in other embodiments T1 and T2 are different. Similarly, in some embodiments D1 is equal to D2, whereas in other embodiments D1 and D2 are different. As shown in FIG. 6, the pillow cushion 102 may not include a core cushion 150, and the cushioning grid 120 extends from the top of the pillow cushion 102 to the bottom. As also shown, the diameter D1 of the voids 124 and the thickness T1 of the interconnected walls 122 of the cushioning grid 120 is consistent through the pillow cushion 102. Still in other embodiments, the diameter D1 of the voids 124 and the thickness T1 of the interconnected walls 122 can vary from one side of the pillow cushion 102 to another. In some embodiments, the pillow cushion 102 is split into one or more zones (e.g., corners, middle, sides, top, bottom, etc.) and the diameter D1 of the voids 124 and the thickness T1 of the interconnected walls 122 in one or more of the zones may be different than the diameter D1 of the voids 124 and the thickness T1 of the interconnected walls 122 in another zone.

Referring now to FIG. 7, another embodiment of the cushioning grid 120 is shown where the interconnected walls 122 define a plurality of voids 124 which define a regular array of rhombi (e.g., squares, diamonds, etc.). The largest angle of any wall 122 of the cushioning grid relative to the axis 121 parallel to the first central axis 118 and/or the width 114 of the pillow cushion 102 represented by θ₁ is 45° relative to the second central axis 119, and the complementary angle θ₂ is 45° relative to the 118. Referring now to FIG. 7, the interconnected walls 122 define a plurality of voids 124 which define a regular array of triangles (i.e., triangular array.). The largest angle of any wall 122 of the cushioning grid relative to the axis 121 parallel to the first central axis 118 and/or the width 114 of the pillow cushion 102 represented by θ₁ is 30° relative to the second central axis 119, and the complementary angle θ₂ is 60° relative to the 118.

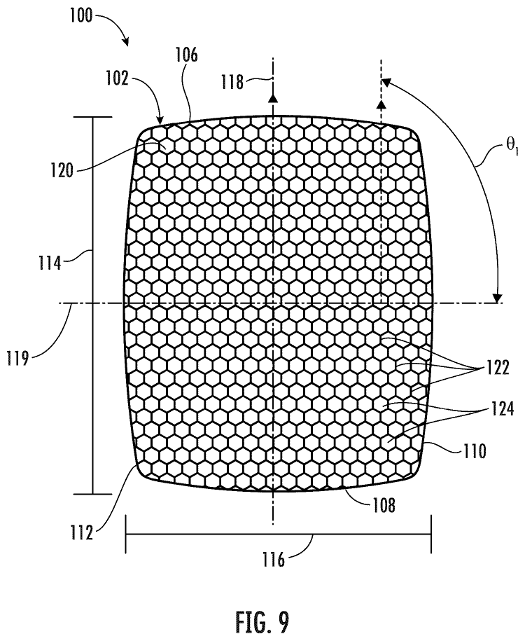

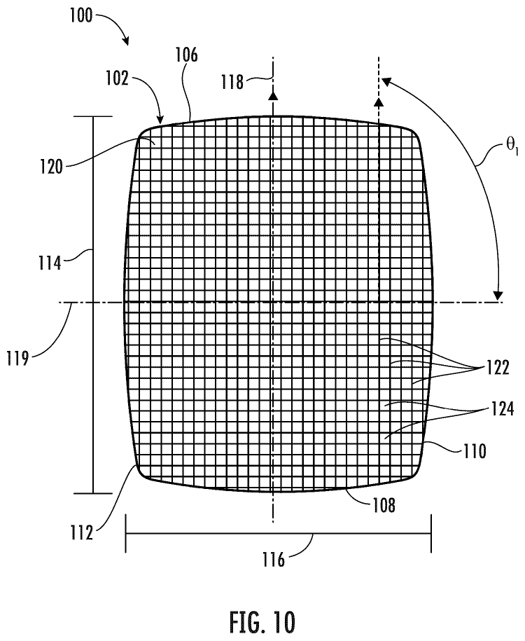

FIGS. 9 and 10 depict cushioning grids 120 with a subset of the interconnected walls 122 extending parallel with the first central axis 118, and which therefore do not match the criteria for θ₁ and θ₂ discussed above with reference to FIGS. 1-8. FIGS. 9 and 10 thus represent less desirable arrangements which will not compress as much along the 118 when a force is applied to one or both of the first side edge 106 the second side edge 108 substantially parallel with the 118. This is due to each of these cushioning grids 120 including walls 122 that extend parallel or substantially parallel to a width 114 or a central axis 118 of the pillow cushion 102, the cushioning grid, 120 and the core cushion 150, if any, or to opposed directions in which the pillow cushion 102 is expected to be compressed (i.e., from the top to the bottom of each illustration). The angle θ₁ in each illustration refers to the largest angle of any wall 122 of the cushioning grid 120 to the depth 116 of the pillow cushion 102, which is the dimension between the front edge 110 and the back edge 112. In FIGS. 9 and 10 the angle θ₁ is 90°. The maximum angle of 90° of each of FIGS. 9 and 10 corresponds to a minimum angle of 0° to the central axis 118 of the pillow cushion 102, or to the opposed directions along which the pillow cushion 102 is designed to be compressed or collapsed. This means that the illustrated cushioning grids 120 of FIGS. 9 and 10 include walls that are oriented parallel to the first central axis 118 and the second central axis 119 of the pillow cushion 102 and to the opposed directions along which the pillow cushion 102 is likely or intended (i.e., designed) to be compressed or collapsed.

A method for designing the pillow 100 (e.g., a collapsible pillow, such as a travel pillow, a readily storable pillow, etc.) includes determining a direction in which the pillow 100 is likely to be collapsed or is intended to be collapsed (e.g., across its width, etc.). In addition, the features of at least one cushioning grid 120 (e.g., shape of voids 124 or prisms in the grid 120, etc.) may be determined. An orientation of each cushioning grid 120 that will enable it to optimally collapse (e.g., without buckling or effectively increasing in thickness, etc.) when the pillow 100 is collapsed in the predetermined direction is also determined.

A method for manufacturing the pillow 100 (e.g., a collapsible pillow, such as a travel pillow, a readily storable pillow, etc.) includes defining the cushioning grid 120 from a suitable cushioning material (e.g., a flexible material, a deformable material, elastomeric gel, etc.). The cushioning grid 120 is defined by defining interconnected walls 122 which define a plurality of voids 124 that are oriented to enable the cushioning grid 120 to collapse along its width 114 without buckling, or without effectively increasing its thickness. More specifically, the cushioning grid 120 may be defined in such a way that none of the walls 122 or substantially none of the walls 122 are oriented parallel to or substantially parallel to the central axis 118 of the pillow 100, or a direction in which the pillow 100 is likely or intended to be collapsed. The interconnected walls 122 of the cushioning grid 120 may define a plurality of voids 124 which may define an array of polygonal prisms (e.g., hexagonal prisms, rhomboidal prisms, triangular prisms, etc.).

Another method for manufacturing the pillow 100 (e.g., a collapsible pillow, such as a travel pillow, a readily storable pillow, etc.) includes providing the core cushion 150 and positioning at least one cushioning grid 120 over an outer surface of the core cushion 150. The core cushion 150 may be collapsible upon application of a force along or in a direction substantially parallel to the central axis 118 across a width 114 of the core cushion 150. Each cushioning grid 120 includes interconnected walls 122 that are oriented so that no wall 122 or substantially no wall 122 of the interconnected walls 122 is oriented parallel to the central axis 118 of the core cushion 150, or substantially parallel to the direction(s) in which the core cushion 150 is likely or intended to be collapsed. The interconnected walls 122 of the cushioning grid 120 may define an array of polygonal prisms (e.g., hexagonal prisms, rhomboidal prisms, triangular prisms, etc.) over the outer surface of the core cushion 150. The cushioning grid 120 may be positioned over the core cushion 150 by placing a cover 140 that carries the cushioning grid 120 over the core cushion 150.

A method for storing and/or transporting the pillow 100 includes collapsing the pillow 100. The pillow 100 may be collapsed by forcing (e.g., pushing, etc.) ends of the pillow 100 together along the central axis 118 through the width 114 of the pillow 100. As the edges 106, 108 of the pillow 100 (e.g., a cushioning grid 120 of the pillow 100, a core cushion 150 of the pillow 100, etc.) are forced together, each cushioning grid 120 of the pillow 100 may collapse. If the cushioning grid 120 is properly oriented (e.g., without substantially any walls 122 of the cushioning grid 120 substantially being parallel or substantially parallel to the central axis 118 of the pillow 100, to the direction in which the pillow 100 is likely or intended to be collapsed, etc.) the cushioning grid 120 may collapse without buckling or, thus, without effectively increasing its thickness. As the at least one cushioning grid 120 collapses, the walls 122 of the at least one cushioning grid 120 may move into spaces, cells, or voids 124 defined between the walls 122, decreasing the volumes of the spaces, cells, or voids 124. Such collapsing may continue until the walls 122 of the at least one cushioning grid 120 contact each other.

Once a collapsing force is removed, the pillow 100 (e.g., the core cushion 150, each cushioning grid 120, etc.) may expand substantially to its relaxed width 114, or substantially to its original dimensions and volume. Such expansion may occur due to the resiliency of one or more parts of the pillow 100 (e.g., its core cushion 150, its cushioning grid(s) 120, etc.).

Although this disclosure provides many specifics, these should not be construed as limiting the scope of any of the claims that follow, but merely as providing illustrations of some embodiments of elements and features of the disclosed subject matter. Other embodiments of the disclosed subject matter, and of their elements and features, may be devised which do not depart from the spirit or scope of any of the claims. Features from different embodiments may be employed in combination. Accordingly, the scope of each claim is limited only by its plain language and the legal equivalents thereto.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and are considered to be within the scope of the disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure.

It is important to note that the constructions and arrangements of the manual treadmill as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A pillow, comprising:
a core cushion comprising an outer surface and opposite side edges; and
at least one cushioning grid superimposed with the outer surface of the core cushion and comprising:
opposite side edges positioned adjacent to the opposite side edges of the core cushion, the opposite side edges of the at least one cushioning grid defining a width;
a central axis extending along the width; and
a plurality of interconnected walls defining a plurality of voids and oriented over the outer surface, the plurality of interconnected walls configured to collapse within the plurality of voids when the opposite side edges of the at least one cushioning grid are forced toward each other in a direction that is substantially parallel to the central axis to collapse the pillow.

2. The pillow of claim 1, wherein the core cushion comprises a foam.

3. The pillow of claim 1, wherein the plurality of interconnected walls of the at least one cushioning grid comprise an elastomeric gel.

4. The pillow of claim 1, wherein the at least one cushioning grid substantially lacks walls that are parallel to the central axis across the width of the at least one cushioning grid.

5. The pillow of claim 4, wherein the plurality of interconnected walls of the at least one cushioning grid are arranged to form the plurality of voids as at least one of:
an array of hexagonal prisms;
an array of rhomboid prisms.; or
an array of triangular prisms.

6. The pillow of claim 1, wherein each wall of the plurality of interconnected walls is oriented along an axis that intersects the central axis.

7. The pillow of claim 1, wherein the plurality of interconnected walls is oriented at an angle less than 90 degrees relative to the central axis.

8. The pillow of claim 1, wherein the outer surface of the core cushion includes oppositely facing major surfaces.

9. The pillow of claim 8, wherein the at least one cushioning grid comprises:
a first cushioning grid superimposed with a first major surface of the oppositely facing major surfaces.

10. The pillow of claim 9, wherein the at least one cushioning grid further comprises:
a second cushioning grid superimposed with a second major surface of the oppositely facing major surfaces.

11. The pillow of claim 1, wherein the at least one cushioning grid substantially surrounds the outer surface of the core cushion.

12. The pillow of claim 1, further comprising:
a cover over the core cushion and carrying the at least one cushioning grid.

13. A method for manufacturing a collapsible pillow, the method comprising:
providing a core cushion collapsible upon application of opposed converging forces along a central axis across a width of the core cushion; and
positioning a cushioning grid comprising interconnected walls over an outer surface of the core cushion, without substantially any wall of the interconnected walls being oriented parallel to the central axis of the core cushion.

14. The method of claim 13, wherein positioning the cushioning grid comprises positioning a plurality of cushioning grids over portions of the outer surface of the core cushion.

15. The method of claim 13, wherein positioning the cushioning grid comprises positioning a cushioning grid in which the interconnected walls define at least one of:
an array of hexagonal prisms over the outer surface of the core cushion;
an array of rhomboid prisms over the outer surface of the core cushion; or
array of triangular prisms over the outer surface of the core cushion.

16. The method of claim 13, wherein positioning the cushioning grid comprises placing a cover that comprises the cushioning grid over the core cushion.

17. A pillow, comprising:
a cushioning grid including opposite side edges and a plurality of interconnected walls, wherein the plurality of interconnected walls are oriented such that the plurality of interconnected walls collapse without substantially increasing in thickness when at least one of the opposite side edges of the cushioning grid is forced toward another of the opposite side edges to collapse the pillow.

18. The pillow of claim 17, wherein the plurality of interconnected walls comprise an elastomeric gel.

19. The pillow of claim 17, wherein none of the plurality of interconnected walls are substantially parallel to a central axis across a width of the cushioning grid.

20. The pillow of claim 17, wherein the plurality of interconnected walls are arranged to form at least one of:
an array of hexagonal prisms;
an array of rhomboid prisms; or
an array of triangular prisms.
